(19) United States
(12) Patent Application Publication
(10) Pub. No.: US 2017/0270421 A1
(43) Pub. Date: Sep. 21, 2017

(54) COMPUTING A QUALITY RANKING OF A SUBJECT

(71) Applicant: Palantir Technologies Inc., Palo Alto, CA (US)

(72) Inventors: Adam Frank, New York City, NY (US); Kyle Patron, New York City, NY (US); Khoa Pham, New York City, NY (US); Maxim Kesin, Woodmere, NY (US); Sanjay Paul, New York City, NY (US); Alexandru Viorel Antihi, Surrey (GB)

(21) Appl. No.: 15/092,119

(22) Filed: Apr. 6, 2016

Related U.S. Application Data
(60) Provisional application No. 62/308,773, filed on Mar. 15, 2016.

(51) Int. Cl. G06N 7/00; G06F 17/30

(52) U.S. Cl. CPC G06N 7/005; G06F 17/3043; G06F 17/3053

(57) ABSTRACT

Aspects of the present disclosure relate to a machine determining a quality ranking of a subject. The machine accesses a current input representing answers to a plurality of questions about the subject, each answer representing a ranking of a quality of the subject at a specified time, where the subject has a geographic location. The machine determines, based on the current input, an overall ranking of the quality of the subject. The machine determines, based on the current input and based on one or more of input received about the subject at a time different from the specified time and input about other subjects proximate to the geographic location, a future ranking of the quality of the subject. The machine transmits a graphical output corresponding to the overall ranking and the determined future ranking of the quality of the subject.

### PRIORITY CLAIM

This application claims priority to U.S. Provisional Patent Application No. 62/308,773, filed on Mar. 15, 2016, entitled “COMPUTING A QUALITY RANKING OF A SUBJECT,” the entire content of which is incorporated herein by reference.

### TECHNICAL FIELD

The subject matter disclosed herein relates to computational analysis devices. In particular, example embodiments may relate to machines configured to generate or display a graphical output representing a quality ranking of a subject.

### BACKGROUND

An overseer may oversee subjects, such as factories that produce goods for sale in stores, to ensure compliance, for instance, with industry or ethical standards. The overseer may detect current compliance based on observations from the subject's site. However, the overseer may also desire to predict future compliance. Technologies that address the problem of predicting future compliance, for example, with industry or ethical standards, may be desirable.

### BRIEF DESCRIPTION OF THE DRAWINGS

Various ones of the appended drawings merely illustrate example embodiments of the present inventive subject matter and cannot be considered as limiting its scope.

FIG. 1 is a diagram of an example networking system for computing a quality ranking of a subject.

FIG. 2 is a block diagram of an example of the data repository of FIG. 1.

FIG. 3 is a block diagram of an example of the server of FIG. 1.

FIGS. 4, 4A, and 4B are block diagrams of examples of the client computing device of FIG. 1.

FIG. 5 is a flowchart illustrating a method for computing a quality ranking of a subject.

FIG. 6 is a diagrammatic representation of a machine in the example form of a computer system within which a set of instructions for causing the machine to perform any one or more of the methodologies discussed herein may be executed.

FIGS. 7A-7C are diagrams of example user interfaces that may be displayed in conjunction with some implementations of the subject technology.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

As noted above, an overseer, such as a retailer, may oversee subjects, such as factories that produce goods for sale in the retailer's stores or individual stores that sell the goods, to ensure compliance, for instance, with industry or ethical standards. For example, a large retailer may be responsible for overseeing multiple different stores and multiple different factories throughout the world. During such overseeing, an employee of the overseer may visit a subject and obtain answers to a set of questions about the subject. The employee of the overseer may determine, based on the answers to the set of questions, whether the subject is currently in compliance. However, the overseer may also desire to predict future compliance and, if there is a low probability of future compliance, to compel the subject to make changes to ensure compliance or to discontinue business with the subject. One technical problem addressed by some aspects of the subject technology is predicting future compliance of subjects based on current and past compliance records, and based on other metadata about the operation of the business outside the compliance records, such as the location of the factories, the geopolitical climate, transportation security, and the like.

According to some implementations, the subject technology provides approaches for predicting future compliance of subjects, for instance, with industry or ethical standards. A computer, such as a server, may receive a current input representing answers to questions about a subject. Each answer may represent a ranking of a quality of a subject at a specified time. For example, one ranking in one answer may indicate how clearly fire escape exits were marked in a factory using color codes (e.g., green for boldly marked, yellow for visibly marked, orange for poorly marked, or red for unmarked) or any other codes indicting levels (e.g., a code for severe/critical, high, medium, and low). The computer may compute, based on the received answers to the questions, an overall ranking of the quality of the subject, which may correspond to the subject's compliance with industry or ethical standards. In addition, the computer may compare the answers that were currently received about the subject with answers that were received about the subject in the past or with answers that were received about other subjects geographically proximate to the subject (e.g., in the same country) to predict a future ranking of the quality of the subject. The current ranking and the predicted future ranking may be presented within a graphical output. Other levers, in addition to geography, can be used for comparing subjects. For instance, subjects can be compared by department, category, and subcategory. In one example, a department is apparel, a category is shoes, and a subcategory is white converse shoes. Comparisons can be made by all factories used by a buyer. For example, if X is the buyer for all chocolate distributed by a distributor in the northeast United States region, X can compare one factory from which he/she obtains chocolate with other factories. The comparison can be weighted by volume of product, total dollar (or other currency) amount, and the like.

The computer may predict the future ranking of the quality of the subject by accessing a data repository that stores multiple answers to multiple questions associated with multiple different subjects, where the answers are generated at different times and the different subjects have different geographic locations. The computer may generate, based on the data in the data repository, a relationship (e.g., a correlation) of past answers to questions to future answers to questions. The relationship may be for all of the subjects in the data repository, all of the subjects in the data repository within a threshold distance (e.g., 10 miles, 100 miles, 500 miles, or 1000 miles) from the subject whose future compliance is to be predicted, or all of the subjects in the same jurisdiction (e.g., city, state, or country) as the subject whose future compliance is to be predicted. The computer may predict, based on the current input and the generated relationship, future answers to questions for the subject. The computer may compute, based on the predicted future answers, the predicted future ranking of the quality of the subject.

According to some aspects, the computer may determine that the predicted future ranking of the subject is within an unacceptable range. The computer may provide an alert that the predicted future ranking of the quality of the subject is within the unacceptable range. The alert may be provided within the graphical output corresponding to the predicted future ranking, for example, by highlighting or flagging the predicted future ranking or placing the predicted future ranking into an easily noticeable box. In addition, a notification, external to the graphical output, may be provided to a messaging address associated with an auditor of the subject. The messaging address may be, for example, an email address, a mobile telephone number capable of receiving short messaging service (SMS) messages, or an address of a mobile device capable of receiving push notifications.

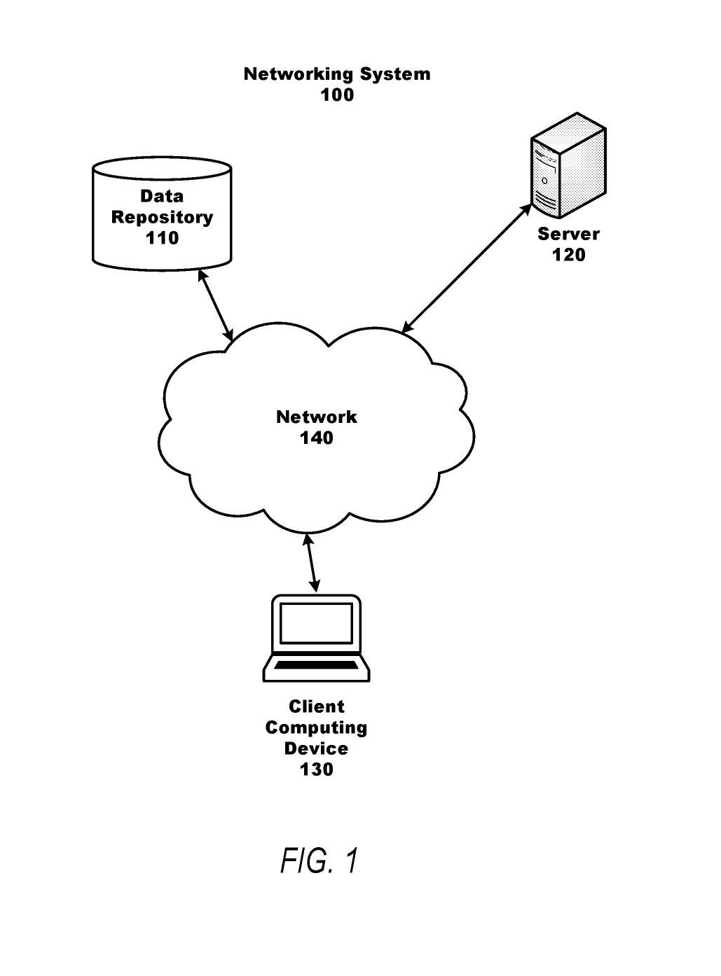

FIG. 1 is a diagram of an example networking system 100 for computing a quality ranking of a subject. As shown, the networking system 100 includes a data repository 110, a server 120, and a client computing device 130 coupled with one another over a network 140. The network 140 may include one or more of the Internet, an intranet, a local area network, a wide area network (WAN), a cellular network, a WiFi network, a virtual private network (VPN), a public network, a wired network, a wireless network, etc.

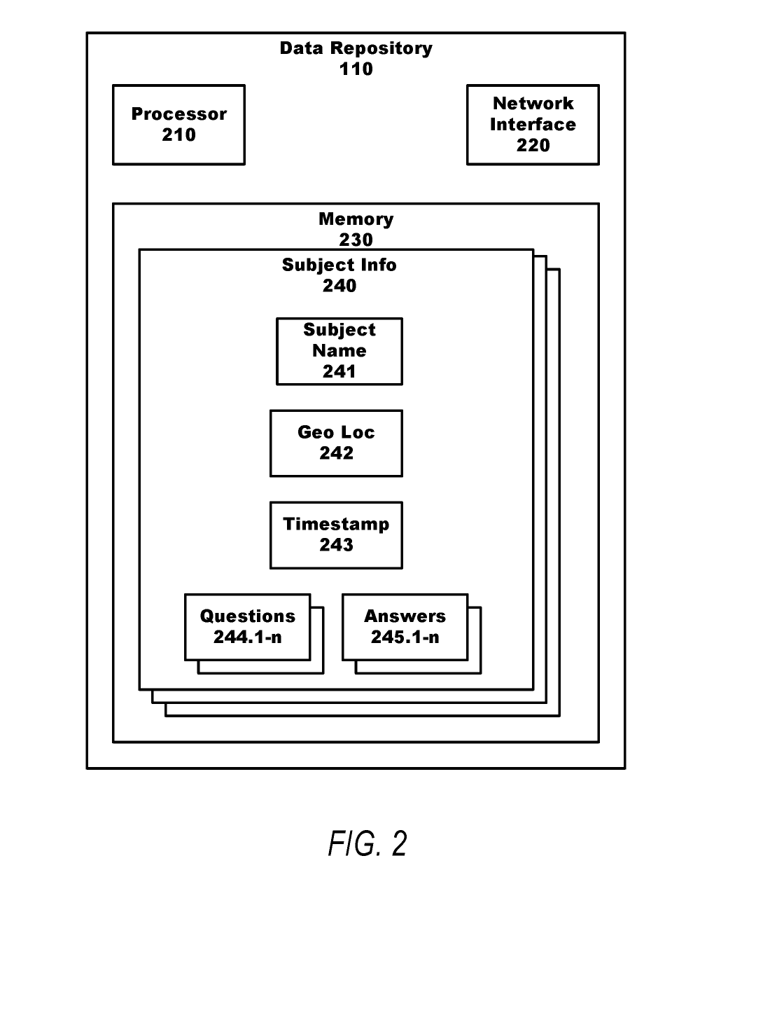

The data repository 110 stores data. For example, the data repository 110 stores information about subjects whose quality rankings are to be computed or have been computed. The information stored about a subject includes, for example, the subject's name, geographic location, and answers to questions. The answers to the questions are associated with a timestamp representing the time when the answers were obtained. The data repository 110 may be implemented as a database or as any other data storage machine. The data repository 110 is described in greater detail in conjunction with FIG. 2.

The server 120 performs operations including storing and accessing information about a subject. The server 120 includes instructions to store answers to questions about subjects in the data repository 110. The server 120 also receives, from the client computing device 130, a request for information about a subject. In response to the request for information, the server 120 accesses the data repository 110. Based on the data accessed from the data repository 110, the server 120 computes a current or a predicted future quality ranking of the subject. The server 120 provides information about the computed current or predicted future quality ranking of the subject for display at the client computing device 130.

The client computing device 130 may include one or more of a laptop computer, a desktop computer, a mobile phone, a tablet computer, a personal digital assistant (PDA), a digital music player, etc. The client computing device 130 includes an application (or multiple applications), such as a web browser or a special purpose application, for communicating with the server 120. Using the application, a user of the client computing device 130 requests the current or the predicted future quality ranking of the subject, or the user provides answers to questions about the subject to the server 120 for storage in the data repository 110.

The subject technology is illustrated in FIG. 1 as being implemented in conjunction with a single data repository 110, a single server 120, and a single client computing device 130 connected via a single network 140. However, the subject technology may be implemented in conjunction with one or more data repositories, servers, client computing devices, or networks. Some implementations may include multiple server farms connected with multiple data repositories and accessed via multiple different client computing devices (e.g., belonging to different employees of the overseer) over the Internet and various private networks.

Furthermore, the subject technology is illustrated in FIG. 1 as being implemented on three different machines—the data repository 110, the server 120, and the client computing device 130. However, in some cases, a single machine may implement the functions of two or more of the machines 110, 120, and 130. For example, a single computer may implement the functions of all three machines with or without network connectivity. Alternatively, two of the machines 110/120, 110/130, or 120/130 may be combined into a single machine. Additionally, while the machines 110, 120, and 130 are shown communicating over the network 140, in some implementations, the network 140 may be replaced with a direct two-way or three-way wired or wireless connection.

FIG. 2 is a block diagram of an example of the data repository 110 of FIG. 1. As shown, the data repository 110 includes a processor 210, a network interface 220, and a memory 230. The processor 210 executes machine instructions, which may be stored in the memory 230. While a single processor 210 is illustrated, the data repository 110 may include multiple processors arranged into multiple processing units (e.g., central processing unit (CPU), graphics processing unit (GPU), etc.). The processor 210 may include one or more processors. The network interface 220 allows the data repository 110 to send and receive data via the network 140. The network interface 220 may include one or more network interface cards (NICs). The memory 230 stores data or instructions. As shown, the memory 230 includes subject information (“subject info”) 240.

The subject information 240 includes information about a subject. While only one item of subject information 240 is illustrated in detail, multiple items of subject information may be stored. The subject information 240 includes a subject name 241, a geographic location (“geo loc”) 242, a timestamp 243, questions 244.1-n, and answers 245.1-n.

The subject name 241 includes a name of the subject, for example, “ABC Factory.” In some cases, a subject may have multiple different names, and intelligence, such as string comparison, linguistic analysis, and geographic analysis, is used to determine that two subject name fields which have different texts correspond to the same subject. For example, “X & Y Grocer” and “X Y Grocery Store” may refer to the same subject, especially if they are located at the same or very proximate geographic locations.

The geographic location 242 represents a geographic location of the subject. The geographic location 242 is, in some cases, represented as a street address, a latitude and longitude, a city and a state, or a city and a country.

The timestamp 243 represents a time when the answers 245.1-n to the questions 244.1-n are obtained. The timestamp includes, in some cases, only a year (e.g., “2016”), a month and year (e.g., “February 2016”), a date (e.g., “10 February 2016”), or an exact time (e.g., “10 February 2016, 17:10:16 Eastern Standard Time”).

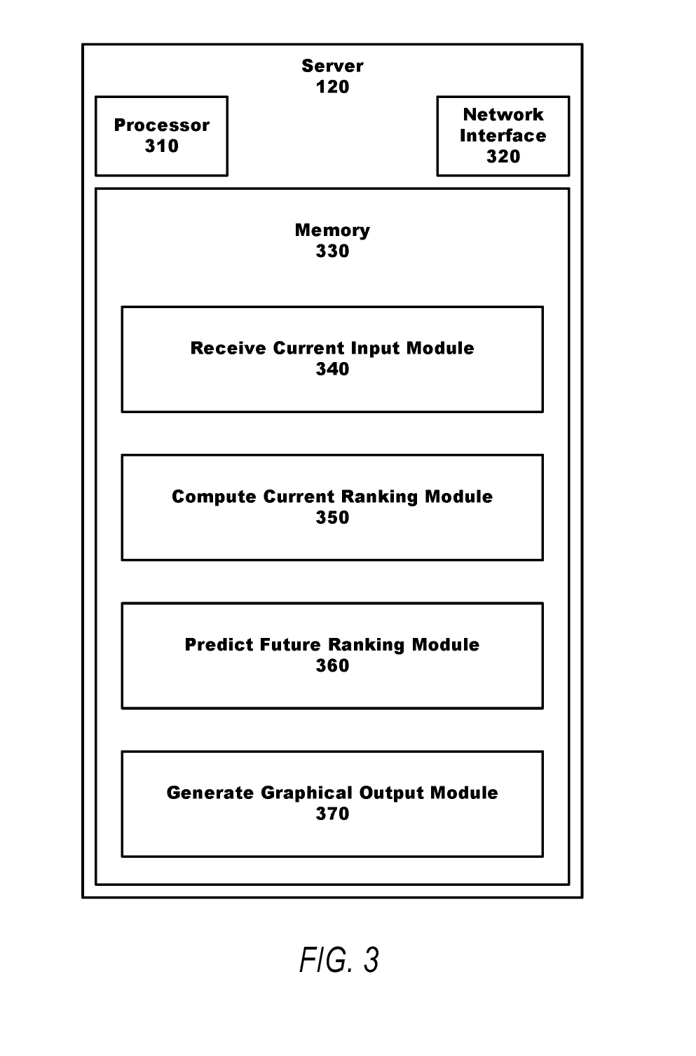

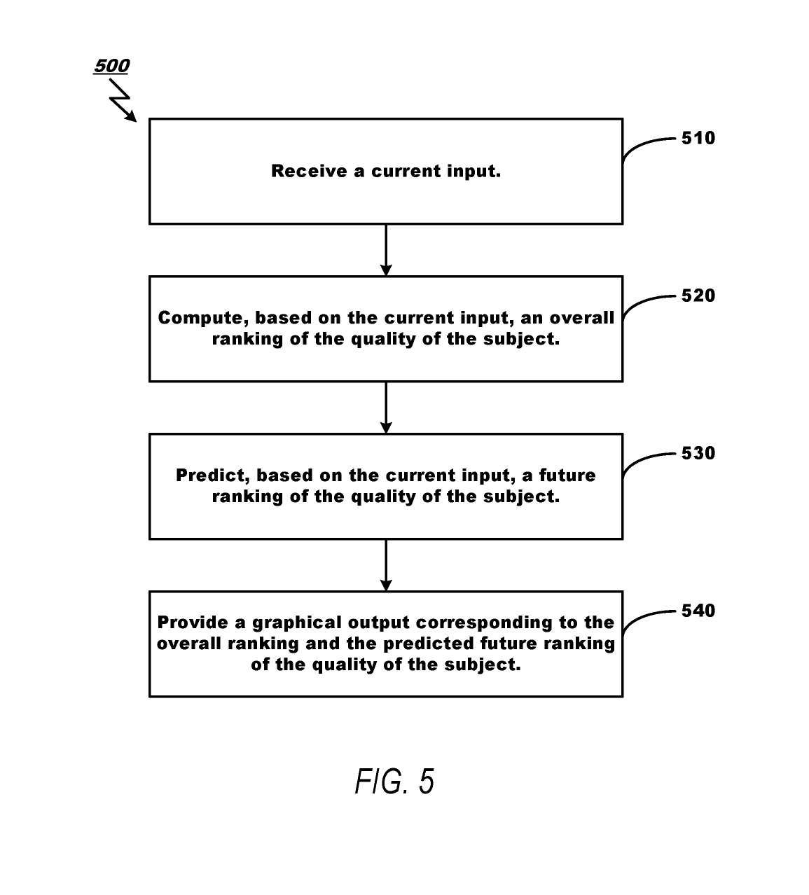

According to some implementations, the questions 244.1-n include a set of questions related to the quality of the subject that is to be ranked. For example, if the quality of the subject is a quality of food at a fast food restaurant, the questions 244.1-n include, for example, “What is the cooking time of the meat?” “What is the cooking time of the vegetables?” “What is the freshness of the vegetables?” “How is the refrigeration of the vegetables?” and “What is the freshness of the bread?” Some of the questions 244.1-n are associated with the answers 245.1-n, which are generated automatically (e.g., by measuring a temperature of an operational refrigerator or oven) or manually (e.g., by an employee of the overseer visiting the subject). For example, question 244.k are associated with answer 245.k (where k is a number between 1 and n). According to some examples, the answer 245.k is a qualitative answer (e.g., one of “good,” “ok,” “mediocre,” or “very poor,” or one of “green,” “yellow,” “orange,” or “red”). The answers 245.1-n are used, by the server 120, to compute the quality ranking of the subject corresponding to the subject information 240 at the time corresponding to the timestamp 243, as described in greater detail in conjunction with FIGS. 3 and 5.

FIG. 3 is a block diagram of an example of the server 120 of FIG. 1. As shown, the server 120 includes a processor 310, a network interface 320, and a memory 330. The processor 310 executes machine instructions, which are stored in the memory 330. Alternatively, the machine instructions (e.g., modules) may be fully or partly hard wired into the processor, as described in greater detail below. While a single processor 310 is illustrated, the server 120 may include multiple processors arranged into multiple processing units (e.g., CPU, GPU, etc.). The processor 310 may include one or more processors. The network interface 320 allows the server 120 to send and receive data via the network 140. The network interface 320 may include one or more NICs. The memory 330 stores data or instructions. As shown, the memory 330 includes a receive current input module 340, a compute current ranking module 350, a predict future ranking module 360, and a generate graphical output module 370.

The receive current input module 340 is configured to receive a current input representing answers to multiple questions about a subject. Each answer represents a ranking of a quality of the subject at a specified time. The subject may have a geographic location. Upon receiving the current input, the receive current input module 340 stores the current input in the data repository 110, for example as the subject information 240 within the memory 230. The name of the subject corresponds to the subject name 241. The geographic location of the subject corresponds to the geographic location 242. The specified time in the current input corresponds to the timestamp 243. The multiple questions and answers from the current input correspond to the questions 244.1-n and the answers 245.1-n, respectively.

The compute current ranking module 350 is configured to compute, based on the current input, an overall ranking of the quality of the subject. According to some implementations, the answers to the questions in the current input correspond to a ranking of qualities of the subject, such as “good,” “fair,” or “poor” or “red,” “yellow,” or “green.” The computed overall ranking is, in some cases, a function of the rankings in the answers, such as the lowest ranking from among the answers, the median ranking from among the answers, or the 85^{th} percentile lowest ranking from among the answers (such that 15% of the answers are below the computed overall ranking and 85% of the answers are above the computed overall ranking). In some cases, the questions include some questions that, if answered in a certain manner, cause the overall ranking to be placed in the lowest quality category regardless of the other answers to the other questions. For example, questions for a construction contractor may include the question, “Are warning signs clearly posted and immediately visible near dangerous areas?—Immediately visible/Posted but only visible after inspection/No.” If the answer is “No,” the construction contractor may automatically be assigned the lowest overall ranking (e.g., “severe,” “critical,” “poor” or “red”) regardless of the answers to the other questions about the construction contractor.

The predict future ranking module 360 is configured to predict, based on the current input and data stored in the data repository 110, a future ranking of the quality of the subject. The data from the data repository 110 relied upon by the predict future ranking module 360 includes subject information 240 for the same subject as in the current input, that was created at a time different from the time of the current input (as determined by the timestamp 243). The data from the data repository 110 relied upon by the predict future ranking module 360 includes, in some cases, subject information 240 for other subjects. The other subjects are, in some cases, proximate to the geographic location of the subject in the current input. For example, the other subjects are within a threshold distance (e.g., 10 kilometers, 100 kilometers, 500 kilometers, 1000 kilometers) of the subject in the current input. Alternatively, the other subjects are located within the same jurisdiction (e.g., city, state, or country) as the subject in the current input.

The operation of the predict future ranking module 360 includes, in some cases, generating a predictive model by correlating past answers to questions to future answers to questions, and correlating answers to a first question to answers to a different second question. Using the generated relationship, the predict future ranking module 360 predicts future answers to questions of the subject of the current input. The predict future ranking module 360 computes, based on the predicted future answers, the predicted future ranking of the subject. In some cases, the operation of the predict future ranking module includes accessing past violation history, determining a distribution of the severity of past violations, and predicting a severity of future violations based on the determined distribution of the severity of past violations. However, the subject technology may be applicable to any type of model that generates a risk score.

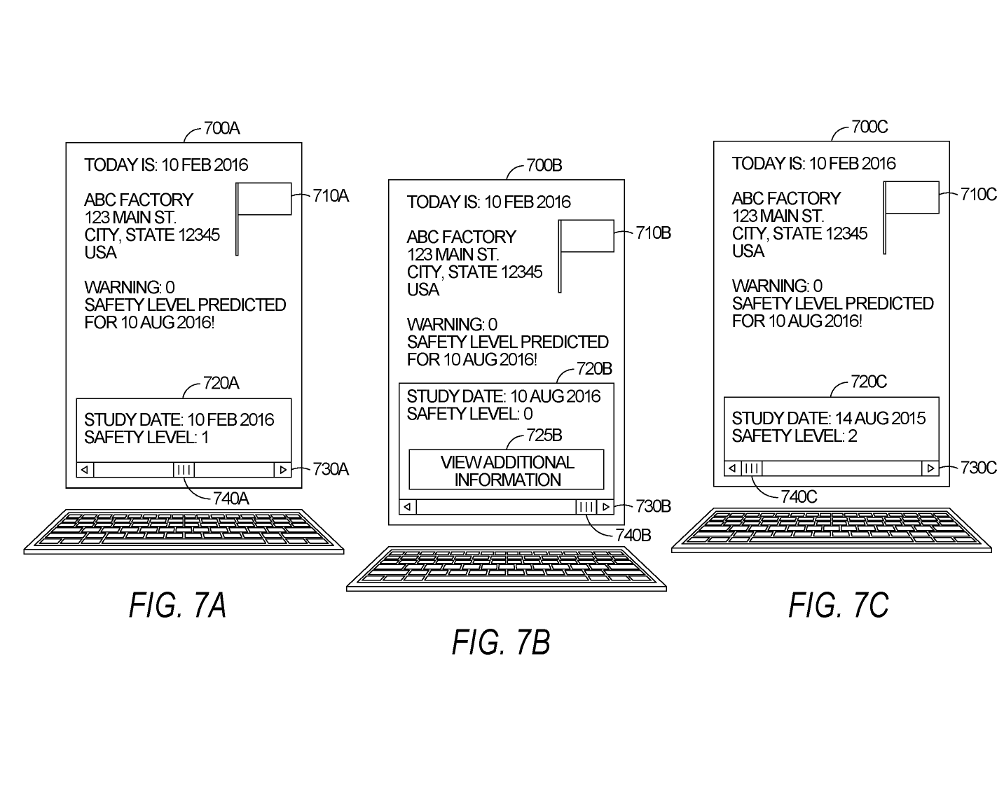

The generate graphical output module 370 is configured to generate a graphical output associated with the current ranking and the predicted future ranking computed by the compute current ranking module 350 and predict future ranking module 360. The graphical output is provided to the client computing device 130 for presentation to a user at the client computing device 130. Examples of the graphical output are provided in conjunction with FIGS. 7A-7C and are discussed in greater detail in conjunction with those figures.

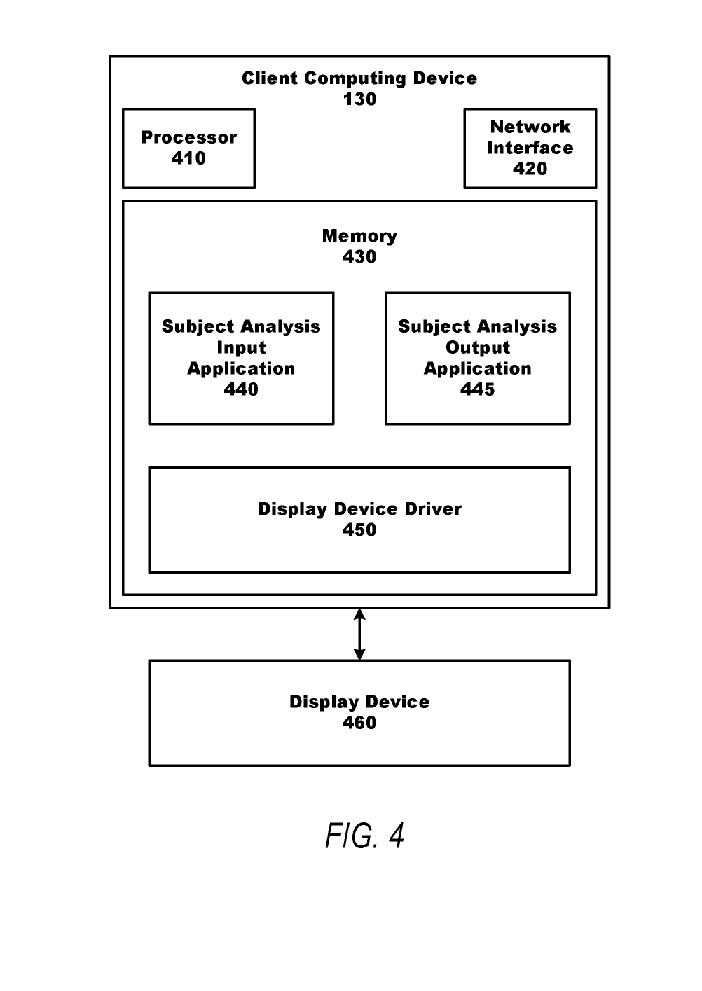

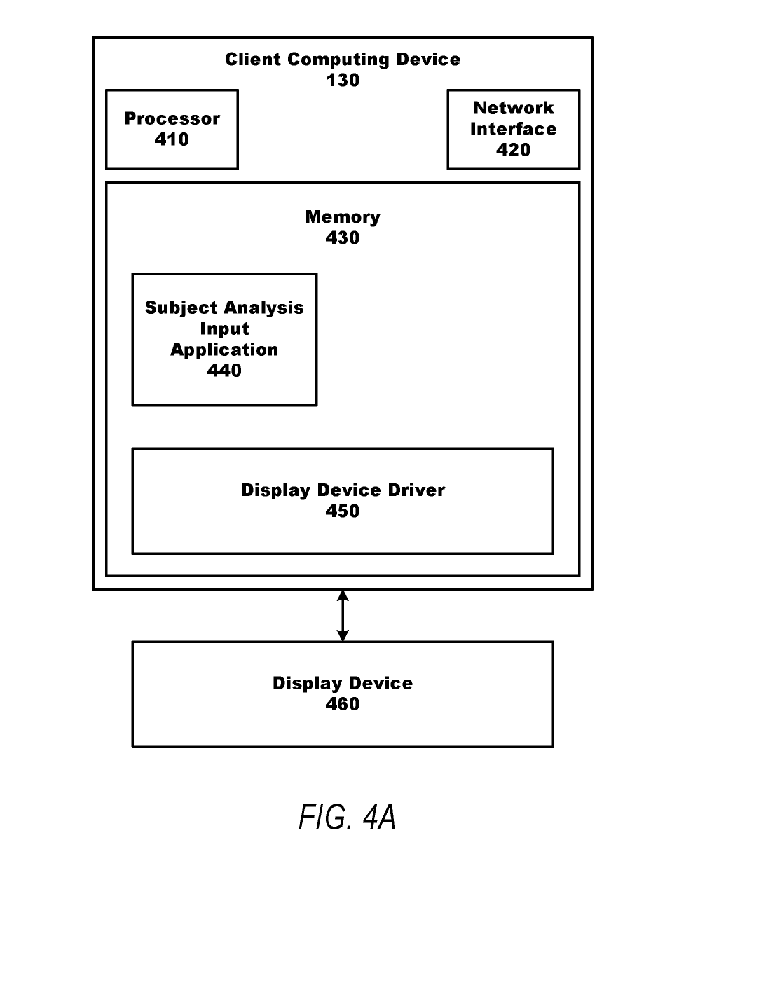

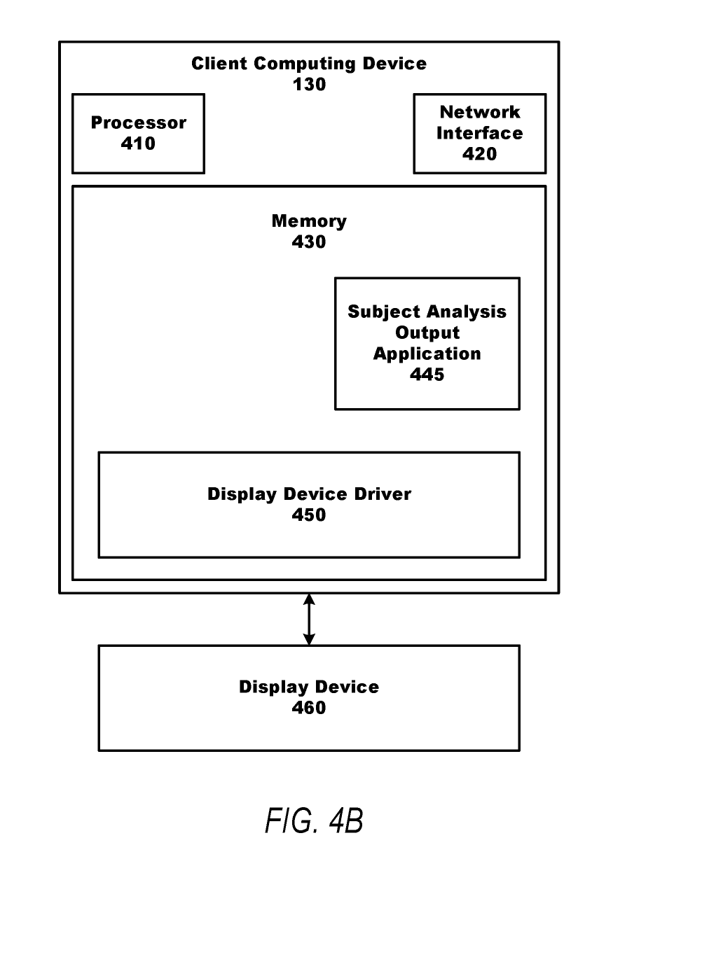

FIG. 4 is a block diagram of an example of the client computing device 130 of FIG. 4. As shown, the client computing device 130 includes a processor 410, a network interface 420, and a memory 430. The client computing device is also coupled with a display device 460, which may include one or more monitors, screens, touchscreens, or projectors. The display device 460 may be an input/output device, such as a touchscreen, or an output device, such as a non-touch monitor. If the display device 460 is an output device, the client computing device 130 may be coupled with other input device(s), such as a keyboard or a mouse. The processor 410 executes machine instructions, which may be stored in the memory 430. While a single processor 410 is illustrated, the client computing device 130 may include multiple processors arranged into multiple processing units (e.g., CPU, GPU, etc.). The processor 410 may include one or more processors. The network interface 420 allows the client computing device 130 to send and receive data via the network 140. The network interface 420 may include one or more NICs. The memory 430 stores data or instructions. As shown, the memory 430 includes a subject analysis input application 440, a subject analysis output application 445, and a display device driver 450.

The subject analysis input application 440 is configured to prompt a user of the client computing device 130 to provide the current input representing the answers to the questions about the subject. According to some examples, the user visits the subject and records the answers to the questions on a paper. The user then scans the paper into the client computing device 130 or manually copies the answers to the questions from the paper to the client computing device 130, using input devices such as a touchscreen, keyboard, or mouse. Alternatively, the client computing device 130 may be a portable mobile phone, tablet computer, or laptop computer which the user takes with himself or herself when visiting the subject's site, and into which the user enters the answers to the questions while making observations at the subject's site.

The subject analysis output application 445 is configured to receive, from the server 120, the generated graphical output corresponding to the overall ranking and the predicted future ranking of the quality of the subject. Upon receiving the generated graphical output, the subject analysis output application 445 presents the generated graphical output via the display device 460, for example, by invoking the display device driver 450.

Either the subject analysis input application 440 or the subject analysis output application 445 may be implemented within a general purpose application, such as a web browser. Alternatively, the subject analysis input application 440 or the subject analysis output application 445 may be a standalone application running on a mobile phone, a tablet computer, a laptop computer, a desktop computer, or an application hard wired into the processor 410 or the memory 430.

The display device driver 450 is configured to display information via the display device 460. The displayed information includes, for instance, prompts to provide the current input representing the answers to the questions about the subject. The displayed information includes, for instance, the generated graphical output from the server 120 as illustrated, for example, in FIGS. 7A-7C and described in greater detail in conjunction with those figures.

As illustrated in FIG. 4, the same client computing device 130 is used for inputting subject data (by the subject analysis input application 440) and outputting subject data (by the subject analysis output application 445). However, it should be noted that, in some cases, different client computing devices can be used for inputting subject data and outputting subject data. In one example, an auditor uses his/her laptop computer, which runs the subject analysis input application 440, to input subject data, and an investigator, different from the auditor, uses his/her desktop computer, which runs the subject analysis output application 445, to display the output data. Examples of client computing devices 130 that include only a portion of the components shown in FIG. 4 are shown in FIG. 4A and FIG. 4B. The client computing device 130 of FIG. 4A has the subject analysis input application 440 and lacks the subject analysis output application 445. The client computing device 130 of FIG. 4A has the subject analysis output application 445 and lacks the subject analysis input application 440.

FIGS. 2, 3, and 4 illustrate computing devices storing data (e.g., subject information 240) and instructions (e.g., modules 340, 350, 360, and 370, applications 440 and 445, and driver 450) in memory 230, 330, or 430. The processors 210, 310, and 410 can access software data and instructions stored in the memories 230, 330, and 430. However, according to some implementations, the data or instructions may be implemented in hardware modules that are hard wired into the processors or the memories. In other words, the data, modules, applications, and drivers may be implemented using only software, only hardware, or a combination of software and hardware.

FIG. 5 is a flowchart illustrating a method 500 for computing a quality ranking of a subject. The method 500 is described herein as being implemented at the server 120 working in conjunction with the data repository 110 and the client computing device 130. However, in some cases, a machine different from the server 120 may implement the method 500.

The method 500 begins at step 510, where the receive current input module 340 of the server 120 receives (e.g., from the client computing device 130) a current input representing answers to a plurality of questions about a subject. Each answer represents a ranking of a quality of the subject at a specified time. The subject may have a geographic location. The answers may be entered into the client computing device 130 by a user and provided to the server 120 via the network 140. Alternatively, the answers may be automatically generated by the client computing device 130 and automatically transmitted to the server 120, without any user involvement. For example, a question may ask about the temperature of a freezer and refrigerator in a restaurant or grocery store. The temperature may be measured by a digital thermometer installed in the freezer and the refrigerator and automatically transmitted from the digital thermometer to the server 120. As a result of this implementation, the server 120 may store multiple readings of the temperature instead of a single reading. Using multiple readings may cause discovery of additional information, for example, that occasionally the freezer or refrigerator stops working.

At step 520, the compute current ranking module 350 of the server 120 computes, based on the current input, an overall ranking of the quality of the subject. The overall ranking may be computed based on the answers to the questions, which may include rankings of qualities of the subject (e.g., “customer service representatives are enthusiastic and polite”) using criteria such as “red,” “yellow,” or “green” or “excellent,” “good,” “mediocre,” or “bad.” The answers to the questions, which include these rankings of qualities or quantitative values (e.g., the temperature of the refrigerator), may be stored in the data repository 110 and originally generated at the client computing device 130, as discussed in other parts of this application. For example, the overall ranking may correspond to any combination of relative or absolute rankings, for instance, a lowest ranking from any answer, a median ranking of the answers, an 85^{th} percentile ranking, or a 15^{th} percentile ranking. Relative may include mean, median, percentile, and the like. Absolute rankings may correspond to mutually exclusive buckets or categories, such as severe, high, medium, low risk, and the like.

At step 530, the predict future ranking module 360 of the server 120 predicts, based on the current input and based on one or more of input received about the subject at a time different from the specified time and input about other subjects, a future ranking of the quality of the subject. The input received about the subject at the time different from the specified time and the input about other subjects may be stored at the data repository 110 and made accessible to the server 120 via the network 140. The server 120 accesses the data repository 110, which stores multiple answers to multiple questions associated with multiple different subjects (e.g., multiple items of subject information 240). The multiple different subjects may be geographically located within a threshold distance of the subject being studied or within the same jurisdiction as the subject being studied. The server 120 generates, based on the data in the data repository 110, a relationship of past answers to questions to future answers to questions. The server 120 then predicts, based on the current input and the generated relationship, future answers to questions for the subject or a severity level of future violations. The server 120 computes, based on the predicted future answers or predicted severity level, the predicted future ranking of the quality of the subject.

At step 540, the generate graphical output module 370 of the server 120 provides a graphical output corresponding to the overall ranking and the predicted future ranking of the quality of the subject. The server 120 may provide the graphical output, via the network 140, to the client computing device 130 for presentation to a user at the client computing device 130. According to some aspects, the graphical output includes a scroll bar with a scroll thumb. While viewing the graphical output, the user may move the scroll thumb in a first direction (e.g., right or down) to move forward in time and view rankings further into the future or less far into the past. For example, if it is February 2016, and the computed ranking for February 2016 is displayed, moving the scroll thumb to the right causes a predicted ranking for March 2016 to be displayed. The user moves the scroll thumb in a second direction (e.g., left or up) opposite the first direction to move backward in time and view rankings further into the past or less far into the future. For example, if it is February 2016, and the computed ranking for February 2016 is displayed, moving the scroll thumb to the left causes the past computed ranking for January 2016 to be displayed. Moving the scroll thumb even further to the left causes the past computed ranking for December 2015 to be displayed.

Multiple approaches for moving the scroll thumb in the first or second direction may be used. For example, the scroll thumb may be moved by placing a finger over the scroll thumb on a touch screen and dragging the scroll thumb along the scroll bar. Alternatively, a cursor may be placed over the scroll thumb and the scroll thumb may be “clicked and dragged” along the scroll bar. In another alternative, touching (with a finger on a touchscreen) or clicking (with a mouse) arrows on the scroll bar may cause the scroll thumb to be moved in the first direction or the second direction, based on the direction of the arrow.

According to some implementations, the predict future ranking module 360 of the server 120 determines that the predicted future ranking of the quality of the subject is within an unacceptable range. The server 120 provides an alert that the predicted future ranking of the quality of the subject is within the unacceptable range. The alert is, in some cases, provided for display at the client computing device 130 within the graphical output corresponding to the predicted future ranking. The alert is, in some cases, provided in a notification external to the graphical output, for example, as a notification sent to a messaging address associated with an auditor of the subject. The messaging address may be an email address, a mobile phone number capable of accepting SMS messages, a push notification address of a mobile phone or tablet computer, a fax number, a printing address of a network printer, etc. After step 540, the method 500 ends.

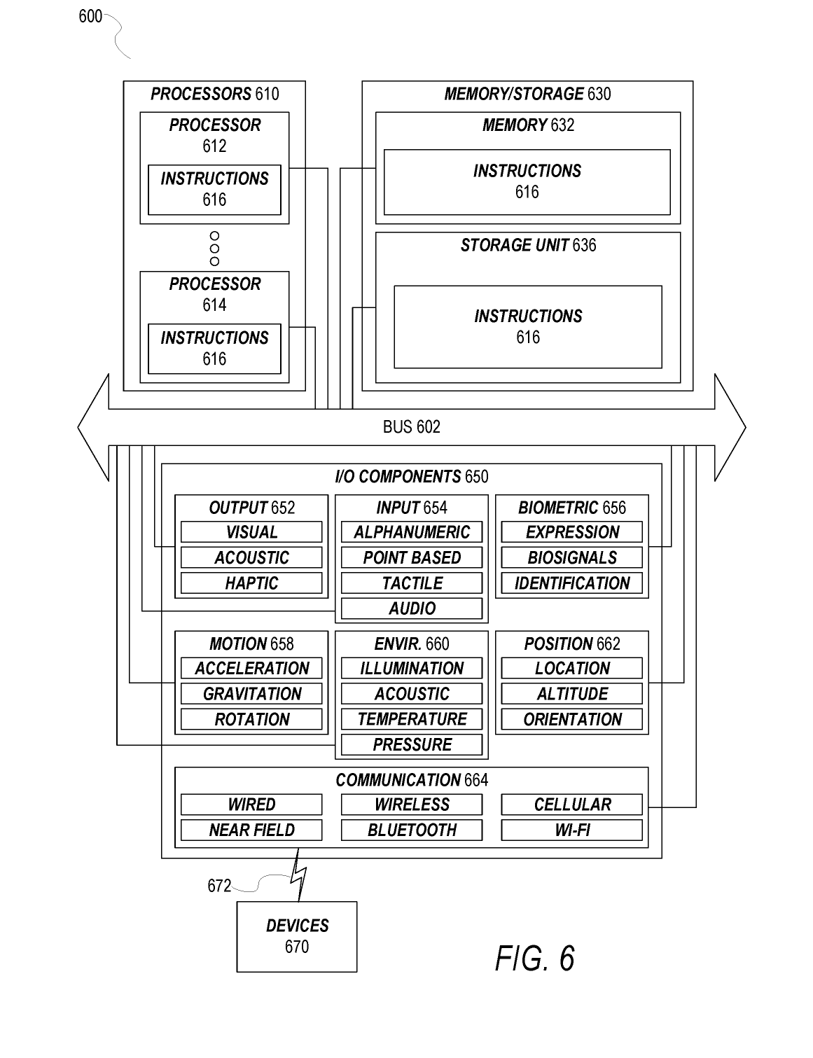

FIG. 6 is a block diagram illustrating components of a machine 600 (e.g., data repository 110, server 120, or client computing device 130), according to some example embodiments, able to read instructions from a machine-readable medium (e.g., a machine-readable identification medium, such as the memory 230, 330, or 430) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. The instructions transform the general, non-programmed machine into a particular machine programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 600 capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610 (which may correspond, for example, to the processor 210, 310, or 410), memory/storage 630 (which may correspond, for example, to the memory 230, 330, or 430), and I/O components 650, which may be configured to communicate with each other such as via a bus 602. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an application-specific integrated circuit (ASIC), a Radio-Frequency Integrated Circuit (RFIC), another processor, or any suitable combination thereof) may include, for example, a processor 612 and a processor 614 that may execute the instructions 616. The term “processor” is intended to include a multi-core processor that may comprise two or more independent processors (sometimes referred to as “cores”) that may execute instructions contemporaneously. Although FIG. 6 shows multiple processors, the machine 600 may include a single processor with a single core, a single processor with multiple cores (e.g., a multi-core processor), multiple processors with a single core, multiple processors with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of the processors 610 are examples of machine-readable media.

As used herein, “machine-readable medium” means a device able to store instructions and data temporarily or permanently, and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine (e.g., processors 610), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

Furthermore, the machine-readable medium is non-transitory in that it does not embody a propagating signal. However, labeling the tangible machine-readable medium “non-transitory” should not be construed to mean that the medium is incapable of movement—the medium should be considered as being transportable from one real-world location to another. Additionally, since the machine-readable medium is tangible, the medium may be considered to be a machine-readable device.

The I/O components 650 may include a wide variety of components to receive input, provide output, produce output, transmit information, exchange information, capture measurements, and so on. The specific I/O components 650 that are included in a particular machine will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to devices 670 via a coupling 672. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF4117, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

FIGS. 7A-7C are diagrams of example user interfaces 700A, 700B, and 700C that may be displayed in conjunction with some implementations of the subject technology. The example user interfaces 700A, 700B, and 700C may be presented at the display device 460 of the client computing device 130.

FIG. 7A illustrates the example user interface 700A. As shown, the user interface 700A includes a representation of today's date “10 Feb 2016,” and a name and address of a subject being studied “ABC Factory.” A flag 710A is shown to alert the user that a predicted future ranking of the quality of the subject (safety level) is within an unacceptable range. In addition, the text “WARNING: RED SAFETY LEVEL PREDICTED FOR 10 AUG 2016!” appears within the user interface 700A to highlight this information to the user. The user interface 700A further includes a date/quality viewing area 720A. The date/quality viewing area 720A displays information about “Study Date: 10 Feb 2016” and notes that, for this date, “Safety Level: ORANGE” was computed. The date/quality viewing area 720A is coupled with a scroll bar 730A that includes a scroll thumb 740A. In some cases, a store may be used in place of a factory, “CRITICAL” may be used in place of “RED,” “HIGH” may be used in place of “ORANGE,” and “LOW” may be used in place of “GREEN.” It should be know that the colors represent only one use case and other use cases, that use representations other than colors, may be implemented. In this implementation, CRITICAL, HIGH, and LOW represent levels of lack of safety, not levels of safety. In other words, GREEN/LOW represents a very safe factory.

FIG. 7B illustrates the example user interface 700B. As shown, the user may transition from the user interface 700A to the user interface 700B by moving the scroll thumb 740A/740B to the right along the scroll bar 730A/730B. Similar to the user interface 700A, the user interface 700B includes the flag 710B to quickly alert the user that the predicted future ranking of the quality of the subject (safety level) is within the unacceptable range. In response to the movement of the scroll thumb 740B, the date/quality viewing area 720B now displays information about “Prediction for: 10 Aug 2016” and notes that, for this date, “Safety Level: RED” was predicted. Furthermore, within the date/quality viewing area 720B, a “View Additional Information” button/link 725B is presented to allow the user to view additional information regarding why the predicted safety level is RED. The additional information may include, for example, key questions and answers that caused the RED predicted safety level.

FIG. 7C illustrates the example user interface 700C. As shown, the user may transition from the user interfaces 700A or 700B to the user interface 700C by moving the scroll thumb 740A/740B/740C to the left along the scroll bar 730A/730B/730C. Similar to the user interfaces 700A and 700B, the user interface 700C includes the flag 710C to quickly alert the user that the predicted future ranking of the quality of the subject (safety level) is within the unacceptable range. In response to the movement of the scroll thumb 740C, the date/quality viewing area 720C now displays information about “Study Date: 14 Aug 2015” and notes that, for this date, “Safety Level: GREEN” was computed.

As noted in the above discussion, moving the scroll thumb 740A/740B/740C to the right causes information about dates further forward in time to be displayed in the date/quality viewing area 720A/720B/720C. Moving the scroll thumb 740A/740B/740C to the left causes information about dates further back in time to be displayed in the date/quality viewing area 720A/720B/720C.

The user interfaces 700A, 700B, and 700C allow the user to conveniently access information about the subject (“ABC Factory”) for multiple past and future dates. The scroll bar 730A, 730B, and 730C provides an intuitive interface for quickly accessing this information. As illustrated, the scroll bar 730A, 730B, and 730C allows for movement of the scroll thumb 740A, 740B, and 740C to the left and to the right. However, in an alternative implementation, the scroll bar may allow for movement of the scroll thumb up or down. Furthermore, as shown, the date/quality viewing area 720A, 720B, and 720C allows for information to be displayed about one date at a time. However, in alternative implementations, the date/quality viewing area may display information about multiple dates adjacent to one another simultaneously.

Additional implementations of the subject technology are possible. In some cases, historical audit results are aggregated on the other axis for analysis, for instance, by department, by final store location, by sales, by supplier, and the like. In some cases, the audit questions themselves are aggregated for a group of factories or stores. For example, “50% of the factories that Manufacturer-A uses have forced labor violations,” “25% of the factories in Country-B do not have a secondary fire escape,” and the like.

The above example is described in conjunction with the scroll thumb 740A, 740B, and 740C. However, it should be noted that any navigational user interface element may be used in place of the scroll thumb 740A, 740B, and 740C. The subject technology is not limited to implementations which use scroll thumbs.

FIGS. 7A-7C describe one interface which can be used with the subject technology. However, other interfaces are possible. For example, the subjects may be presented on a map, where each subject is placed over its geographic location and color coded based on a current or predicted future quality ranking of the subject. The user may then be able to select the subject on the map to view additional information. In another implementation, multiple subjects may be categorized by quality score, and the user may be able to search through subjects based on their quality scores, for example, to award subjects with good quality scores or to limit business with subjects with poor quality scores.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

In this document, the terms “a” or “an” are used, as is common in patent documents, to include one or more than one, independent of any other instances or usages of “at least one” or “one or more.” In the appended claims, the terms “including” and “in which” are used as the plain-English equivalents of the respective terms “comprising” and “wherein.” Also, in the following claims, the terms “including” and “comprising” are open-ended; that is, a system, device, article, method or process that includes elements in addition to those listed after such a term in a claim are still deemed to fall within the scope of that claim. Moreover, in the following claims, the terms “first,” “second,” “third,” and so forth are used merely as labels, and are not intended to impose numerical requirements on their objects.

1. A system comprising:
one or more processors; and
a memory comprising instructions which, when executed by the one or more processors, cause the one or more processors to at least:
access a current input representing answers to a plurality of questions about a subject, each answer representing a ranking of a quality of the subject at a specified time, wherein the subject has a geographic location;
determine, based on the current input, an overall ranking of the quality of the subject;
determine, based on the current input and based on input received about the subject at a time different from the specified time and input about other subjects proximate to the geographic location, a future ranking of the quality of the subject; and
electronically transmit, to a computing device for display at the computing device, a graphical output corresponding to the overall ranking and the future ranking of the quality of the subject.

2. The system of claim 1, wherein the one or more processors are further to:
determine that the future ranking of the quality of the subject is within an unacceptable range; and
provide an alert that the future ranking of the quality of the subject is within the unacceptable range.

3. The system of claim 2, wherein the instructions to provide the alert that the future ranking of the quality of the subject is within the unacceptable range comprise instructions to:
transmit for display, within the graphical output corresponding to the future ranking, the alert that the future ranking of the quality of the subject is within the unacceptable range; and
transmit a notification, external to the graphical output, to a messaging address associated with an auditor of the subject.

4. The system of claim 1, wherein the instructions to determine the future ranking of the quality of the subject comprise instructions to:
access a data repository, the data repository storing multiple answers to multiple questions associated with multiple different subjects;
determine, based on data in the data repository, a relationship of past answers to questions to future answers to questions; and
predict, based on the current input and the determined relationship, future answers to the plurality of questions for the subject, wherein the future ranking of the quality of the subject is determined based on the predicted future answers.

5. The system of claim 4, wherein the multiple different subjects are geographically located within a threshold distance of the subject or within a same jurisdiction as the subject.

6. The system of claim 1, wherein the graphical output comprises a scroll bar and a scroll thumb, and wherein the electronically transmitting comprises:
causing display of a first ranking of the subject, the first ranking being associated with a first time, wherein the first time is a past time, a current time, or a future time;
receiving a first user input corresponding to moving the scroll thumb in a first direction along the scroll bar; and
causing display, in response to the first user input corresponding to moving the scroll thumb in the first direction along the scroll bar, of a second ranking of the subject, the second ranking being associated with a second time, wherein the second time is later than the first time.

7. The system of claim 6, wherein the instructions to provide the graphical output corresponding to the overall ranking and the future ranking of the quality of the subject further comprise instructions to:
receive, after causing display of the second ranking of the subject, a second user input corresponding to moving the scroll thumb in a second direction along the scroll bar, the second direction being different from the first direction; and
cause display, in response to the second user input corresponding to moving the scroll thumb in the second direction along the scroll bar, of a third ranking of the subject, the third ranking being associated with a third time, wherein the third time is earlier than the second time.

8. A non-transitory machine-readable medium comprising instructions which, when executed by one or more processors of a machine, cause the machine to perform operations comprising:
accessing a current input representing answers to a plurality of questions about a subject, each answer representing a ranking of a quality of the subject at a specified time, wherein the subject has a geographic location;
determining, based on the current input, an overall ranking of the quality of the subject;
determining, based on the current input and based on input received about the subject at a time different from the specified time and input about other subjects proximate to the geographic location, a future ranking of the quality of the subject; and
electronically transmitting, to a computing device for display at the computing device, a graphical output corresponding to the overall ranking and the future ranking of the quality of the subject.

9. The non-transitory machine-readable medium of claim 8, wherein the operations further comprise:
determining that the future ranking of the quality of the subject is within an unacceptable range; and
providing an alert that the future ranking of the quality of the subject is within the unacceptable range.

10. The non-transitory machine-readable medium of claim 9, wherein providing the alert that the future ranking of the quality of the subject is within the unacceptable range comprises:
transmitting for display, within the graphical output corresponding to the future ranking, the alert that the future ranking of the quality of the subject is within the unacceptable range; and
transmitting a notification, external to the graphical output, to a messaging address associated with an auditor of the subject.

11. The non-transitory machine-readable medium of claim 8, wherein determining the future ranking of the quality of the subject comprises:
accessing a data repository, the data repository storing multiple answers to multiple questions associated with multiple different subjects;
determining, based on data in the data repository, a relationship of past answers to questions to future answers to questions; and
predicting, based on the current input and the determined relationship, future answers to the plurality of questions for the subject, wherein the future ranking of the quality of the subject is determined based on the predicted future answers.

12. The non-transitory machine-readable medium of claim 11, wherein the multiple different subjects are geographically located within a threshold distance of the subject or within a same jurisdiction as the subject.

13. The non-transitory machine-readable medium of claim 8, wherein the graphical output comprises a scroll bar and a scroll thumb, and wherein the electronically transmitting comprises:
causing display of a first ranking of the subject, the first ranking being associated with a first time, wherein the first time is a past time, a current time, or a future time;
receiving a first user input corresponding to moving the scroll thumb in a first direction along the scroll bar; and
causing display, in response to the first user input corresponding to moving the scroll thumb in the first direction along the scroll bar, of a second ranking of the subject, the second ranking being associated with a second time, wherein the second time is later than the first time.

14. The non-transitory machine-readable medium of claim 13, wherein providing the graphical output corresponding to the overall ranking and the future ranking of the quality of the subject further comprises:
receiving, after causing display of the second ranking of the subject, a second user input corresponding to moving the scroll thumb in a second direction along the scroll bar, the second direction being different from the first direction; and
causing display, in response to the second user input corresponding to moving the scroll thumb in the second direction along the scroll bar, of a third ranking of the subject, the third ranking being associated with a third time, wherein the third time is earlier than the second time.

15. The non-transitory machine-readable medium of claim 8, wherein the ranking comprises either a qualitative or a quantitative ranking.

16. A method comprising:
accessing, by one or more processors, current input representing answers to a plurality of questions about a subject, each answer representing a ranking of a quality of the subject at a specified time, wherein the subject has a geographic location;
determining, by the one or more processors, based on the current input, an overall ranking of the quality of the subject;
determining, by the one or more processors, based on the current input and based on input received about the subject at a time different from the specified time and input about other subjects proximate to the geographic location, a future ranking of the quality of the subject; and
electronically transmitting, to a computing device for display at the computing device, a graphical output corresponding to the overall ranking and the future ranking of the quality of the subject.

17. The method of claim 16, further comprising:
determining that the future ranking of the quality of the subject is within an unacceptable range; and
providing an alert that the future ranking of the quality of the subject is within the unacceptable range.

18. The method of claim 17, wherein providing the alert that the future ranking of the quality of the subject is within the unacceptable range comprises:
transmitting for display, within the graphical output corresponding to the future ranking, the alert that the future ranking of the quality of the subject is within the unacceptable range; and
transmitting a notification, external to the graphical output, to a messaging address associated with an auditor of the subject.

19. The method of claim 16, wherein determining the future ranking of the quality of the subject comprises:
accessing a data repository, the data repository storing multiple answers to multiple questions associated with multiple different subjects;
determining, based on data in the data repository, a relationship of past answers to questions to future answers to questions; and
predicting, based on the current input and the determined relationship, future answers to the plurality of questions for the subject, wherein the future ranking of the quality of the subject is determined based on the predicted future answers.

20. The method of claim 19, wherein the multiple different subjects are geographically located within a threshold distance of the subject or within a same jurisdiction as the subject.
